(19) United States
(12) Patent Application Publication
(10) Pub. No.: US 2005/0042897 A1
(43) Pub. Date: Feb. 24, 2005

(54) Electrical connector

(76) Inventors: Jian Zhang, Kunsan (CN); Nick Lin, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/925,286

(22) Filed: Aug. 23, 2004

(30) Foreign Application Priority Data
Aug. 22, 2003 (TW) 9292215273

(51) Int. Cl. H01R 12/00

(52) U.S. Cl. 439/71

(57) ABSTRACT

A land grid array connector (1) for electrically connecting a CPU package (3) to a printed circuit board comprises a housing (2) and a number of contacts (23) received in passageways (22) of the housing. The housing has a floor (20) and sidewalls (24,26). The floor and the sidewalls cooperatively define a receiving space for accommodating the package. Block member (269) is formed on inner side of the sidewalls of the housing for protecting inner surface of the sidewalls of the housing from scraping damage during insertion of the package into the housing and during extraction of the package from the housing. Reliable electrical connection between the package and contacts of the land grid array connector is secured.

### BACKGROUND OF THE INVENTION

1. Field of the Invention

The present invention relates to electrical connectors, and more particularly to a land grid array (LGA) connector for electrically connecting an electronic package such as a CPU chip, to a circuit substrate such as a printed circuit board (PCB).

2. Description of the Prior Art

Land grid array (LGA) connectors are commonly used in personal computer (PC) systems, for electrically connecting CPU chips to PCBs. This kind of connectors can avoid soldering procedures during being mounted on the PCBs.

FIG. 7 shows such a conventional LGA connector. The LGA connector comprises an insulative housing 2′ receiving a plurality of contacts 23′ therein, a stiffener 4′ attached to the housing 2′, a load plate 5′ and a lever 6′ pivotally mounted to opposite sides of the housing 2′ respectively. The housing 2′ comprises a floor 20′, two opposite first sidewalls 24′ and two opposite second sidewalls 26′ adjacent the first sidewalls 24′. A plurality of passageways 22′ is defined in the floor 20′, for receiving contacts 23′ therein. The contacts 23′ each protrude outwardly from a top portion of the housing 2′, for connecting with the contact pads (not shown) of the CPU chip 3′. The first sidewalls 24′ each define a plurality of alternate protrusions 240′ and grooves 242′. Bosses 265′, 266′ are respectively formed on the second sidewalls 26′, for positioning and keying the CPU chip 3′. Notches 32′, 33′ are defined in the CPU chip 3′, for engaging with the bosses 265′, 266′ of the housing 2′. The CPU chip 3′ is, thereby, retained in the housing 2′. A step 263′ is formed at place the floor 20′ connecting with the second sidewalls 26′, for supporting the CPU chip 3′ thereon.

In use, the CPU chip 3′ is disposed on the housing 2′. The load plate 5′ is pressed down onto the CPU chip 3′, pressing portions (not numbered) of the load plate 5′ resting on the CPU chip 3′. The lever 6′ is rotated down to engage with one side of the load plate 5′, urging the pressing portion of the load plate 5′ to press on the CPU chip 3′.

When the lever 6′ presses down on the load plate 5′, the pressing portions of the load plate 5′ push down on the CPU chip 3′. Because the load plate 5′ first urges against one side of the CPU chip 3′ near the load plate 5′ engaging with the stiffener 4′, the opposite side of the CPU chip 3′ is liable to bend upwardly. As a result, warp or even horizontal displacement of the CPU chip 3′ occurs. During insertion the CPU chip 3′ into the housing 2′, the sides of the CPU chip is prone to scrape corresponding sidewalls of the housing 2′. This can bring damage to effective electrical connection between the CPU chip 3′ and contacts 23′ of the housing 2′.

Referring also to FIGS. 8 and 9, the CPU chip 3′ is slantwise positioned in the housing 2′, one side of the CPU chip 3′ resting on the step 263′ and the opposite side leaning against the second sidewalls 26′. When the lever 6′ is rotated down to press on the load plate 5′, the pressing portion of the load plate 5′ pushing down on the CPU chip 3′. Then the CPU chip 3′ moves downwardly under the pressing force of the load plate 5′ applied by the lever 6′, sides of the CPU chip 3′ near the second sidewalls 26 abutting against and urging inner surface of the second sidewalls 26. Accordingly, scraping of inner surface of the second sidewalls 26′ happens. Similarly, scraping happens on inner surface of the first sidewalls 24′ and the CPU chip 3′ per se. As a result, parts of inner surface of the sidewalls 24′, 26′ and the CPU chip 3′ scraped-away particulates are scraped away (shown as A of FIG. 3). The scraped-away particulates are prone to drop into the floor 20′ of the housing 2′, blocking up the CPU chip 3′ upwardly. This adversely can effect the firm connection between the CPU chip 3′ and the contacts 23′ near the scraped-away particulates. As a result, reliability of the electrical connection between the CPU chip 3′ and the contacts 23′ of the housing 2′ is accordingly decreased.

Therefore, a new land grid array electrical connector which overcomes the above-mentioned disadvantages of the prior art is desired.

### SUMMARY OF THE INVENTION

Accordingly, one object of the present invention is to provide a new LGA connector, whereby the connector can avoid scraping damage to housing of the connector during insertion a CPU chip into the housing or extraction the CPU chip from the housing.

To achieve the aforementioned object, an LGA connector in accordance with a preferred embodiment of the present invention is provided. The LGA connector comprises an insulative housing, a plurality of contacts received in the housing, a load plate and a lever mounted to opposite sides of the housing respectively. The housing has a bottom floor and sidewalls extending upwardly from the floor. A receiving space is defined between the floor and the sidewalls, for accommodating a CPU chip therein. At least one block member is formed on the sidewalls. Said block member partly protrudes into the receiving space, for avoiding scraping damage of sidewalls of the housing during insertion of the CPU chip into the housing and during extracting of the CPU chip from the housing.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of an LGA connector in accordance with a preferred embodiment of the present invention;

FIG. 2 is an isometric view of a housing of the LGA connector of FIG. 1;

FIG. 3 is an isometric view of a block member of the housing of FIG. 2;

FIG. 4 is an enlarged view of a circled portion IV of FIG. 2;

FIG. 5 is a cross-sectional view taken along a line V-V of FIG. 2, showing the CPU chip being slantwise inserted into the housing;

FIG. 6 is an enlarged view of a circled portion VI of FIG. 5;

FIG. 7 is an exploded, isometric view of a conventional land grid array connector;

FIG. 8 is a cross-sectional view taken along a line VIII-VIII of FIG. 7, showing a CPU chip being slantwise inserted into the LGA connector; and

FIG. 9 is an enlarged view of a circled portion IX of FIG. 8.

### DETAILED DESCRIPTION OF THE PREFERRED EMBODIMENT OF THE INVENTION

Reference will now be made to the drawings to describe the present invention in detail.

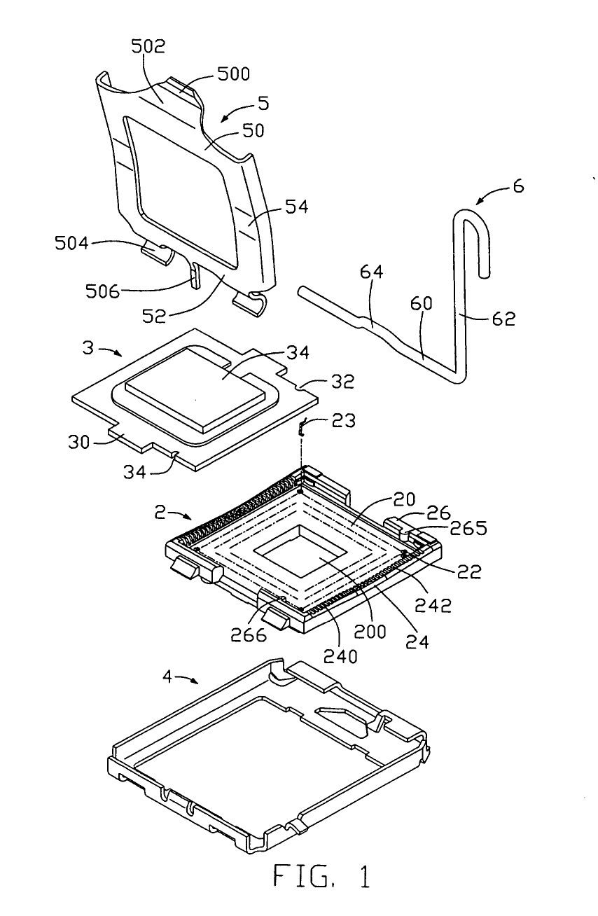

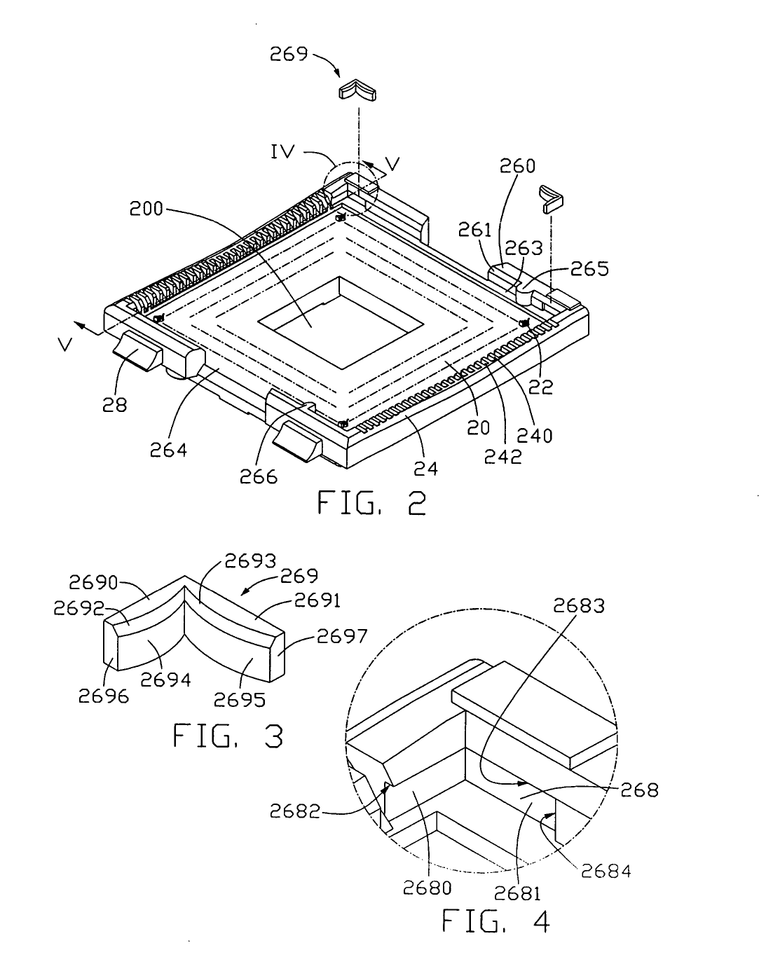

Referring to FIGS. 1 and 2, an LGA connector in accordance with a preferred embodiment of the present invention is provided for electrically connecting a CPU chip 3 to a PCB (not shown). The LGA connector comprises an insulative housing 2, a plurality of contacts 23 received in the housing 2, a stiffener 4 attached to the housing 2 for reinforcing the housing 2, a load plate 5 and a lever 6 pivotably mounted to opposite sides of the housing 2 respectively.

The housing 2 is configured with a bottom floor 20, two opposite first sidewalls 24 and two opposite second sidewalls 26 interconnecting the first sidewalls 24. The floor 20 is disposed between the first and second sidewalls 24,26. A central cavity 200 is defined in the floor 20. A receiving space is defined between the floor 20 and the first and second sidewalls 24,26, for accommodating the CPU chip 3 therein. A plurality of passageways 22 is defined in the floor 20, for receiving the contacts 23 therein. The first sidewalls 24 each form a plurality of alternate protrusions 240 and grooves 242. Slant guiding faces 260 are formed on the second sidewalls 26 and the end of the first sidewalls 24 adjacent the second sidewalls 26, for facilitating insertion the CPU chip 3 into the housing 2. A step 263 is formed in a joint portion of the floor 20 and the second sidewalls 26, to support the CPU chip 3 thereon. This thereby can protect the contacts 23 from damage with excessive pressure. Cutouts 264 are defined in respective middle of the second sidewalls 26, for engaging with the CPU chip 3. This, therefore, facilitates placement the CPU chip 3 into the housing 2 and extraction of the CPU chip 3 thererfrom. First and second bosses 265,266 are respectively formed on inner sides of the second sidewalls 26. The first and second bosses 265,266 depend at bottom thereof on the step 263, for fixing the CPU chip 3 in the space of the housing 2. A pair of locking blocks 28 protrudes from outside of one of the second sidewalls 26, for abutting against and fastening the load plate 5 attached thereon. A recess 268 is defined in a joint portion of the second sidewalls 26 and the first sidewalls 24. The recess 268 is oriented toward the receiving space of the housing 2, in communication there with the space. A complementary block member 269 is disposed in the recess 268(referring to FIG. 3), for protecting inner surface of the sidewalls 24,26 from scraping during insertion of the CPU chip 3 into the housing 2 and during extraction of the CPU chip 3 from the housing 2.

Referring to FIG. 4, the recess 268 has a generally L-shaped configuration. The recess 268 has a vertical first surface 2680, a vertical second surface 2681 interconnecting with the first surface 2680, a horizontal first and second mating faces 2682,2683. The first and second mating faces 2682,2683 are perpendicular to and adjoined with the first and second surfaces 2680,2681 respectively. The recess 268 further has a vertical inward stopping wall 2684, perpendicular to and connecting with both the second surface 2681 and the second mating face 2683.

As referring to FIGS. 2 and 3, the block member 269 is substantially L-shaped, and is made of mental or any other rigid material. The block member 269 has a first and second top surfaces 2690,2691, a first and second auxiliary surfaces 2692,2693 connecting with the first and second top surfaces 2690,2691 respectively. The first and second auxiliary surfaces 2692,2693 slantwise downwardly and are aligned with the guiding face 261 of the housing 2, thereby to guide insertion of the CPU chip 3 into the housing 2. The block member 269 further has a first and second arcuate inner surfaces 2694,2695, and a vertical first and second side faces 2696,2697. The first and second inner surfaces 2694, 2695 are adjoined the auxiliary surfaces 2692,2693 respectively. The first and second side faces 2696,2697 are perpendicular to and connected with the first and second inner surfaces 2694,2695 respectively. In use, the block member 269 is disposed into the recess 268 by an insertion molding procedure or a mechanical interference engagement. The first and second top surfaces 2690,2691 respectively abut against the first and second mating faces 2682,2683 of the recess 268. The outer surfaces (not numbered) opposite to the first and second inner surfaces 2694,2695 engage with the first and second surfaces 2680,2681 respectively. And the second outside wall 2697 abuts against the stopping wall 2684. The block member 269 protrudes partly out inner side of the corresponding sidewalls into the receiving space of the housing 2.

The CPU chip 3 has a generally longitudinal configuration. A pair of rectangular lips 30 respectively extends from two opposite sides of the CPU chip 3. The lips 30 are adapted to engage with the cutouts 264 of the housing 2, for facilitating placement of the CPU chip 3 into the housing 2 and displacement the CPU chip 3 from the housing 2. A first and second notch 32, 33 are respectively defined in the opposite sides of the CPU chip 3, for engaging with the corresponding first and second bosses 265,266 of the housing 2, respectively. Further, a heat sink 34 is attached to a middle portion of top surface (not numbered) of the CPU chip 3, for dissipating heat. In assembly, the CPU chip 3 is pressed down into the housing 2, wherein two opposite sides of the CPU chip 3 are sustained on the step 263, and the corresponding lateral edges of the opposite sides are abutted against the inner surfaces 2694,2695 of the block member 269.

The load plate 5 is generally a rectangular frame. The load plate 5 has a first and second lateral sides 50,52, and two opposite sides (not numbered) connecting the first and second lateral sides 50,52. An engaging portion 500 is arcuately extended from a middle portion of the first lateral side 50. The engaging portion 500 forms an engaging surface 502 thereon. A pair of spaced arcuate clasps 504 symmetrically extends from the second lateral side 52. A fastening leg 506 is formed between the clasps 504, the clasps 504 and the fastening leg 506 engaging with the stiffener 4. The locking blocks 28 of the housing 2 abut against inner surface of the clasps 504, for fastening the load plate 5 on the housing 2. Pressing portions 54 are respectively protrude from a middle portion of the opposite sides to the direction of the space of the housing 2.

The lever 6 is substantially a crank. The lever 6 has a locating portion 60, an operation handle 62, and an offset cam portion 64. The locating portion 60 is pivotably mounted on one side of the load plate 5. The operation handle 62 extends perpendicularly from an end of the locating portion 60. The cam portion 64 is parallel to the locating portion 60 and formed at a middle portion thereof. The operation handle 62 is driven to move the connector between an open position and a closed position.

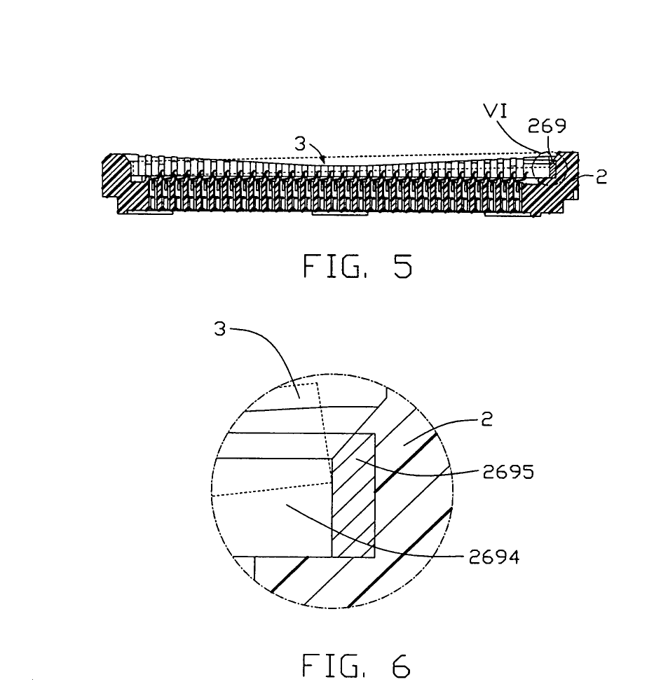

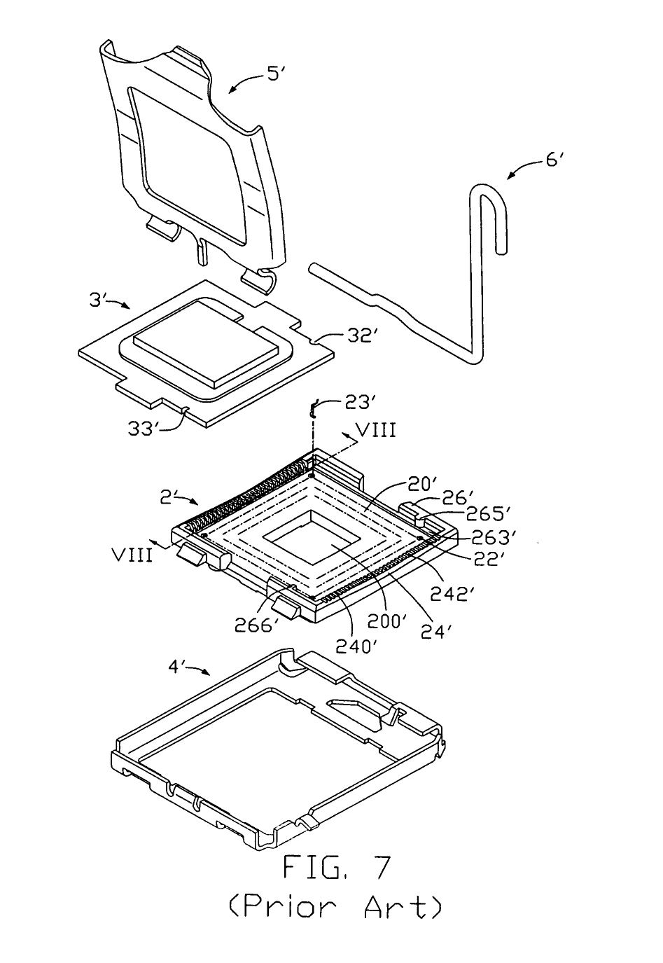

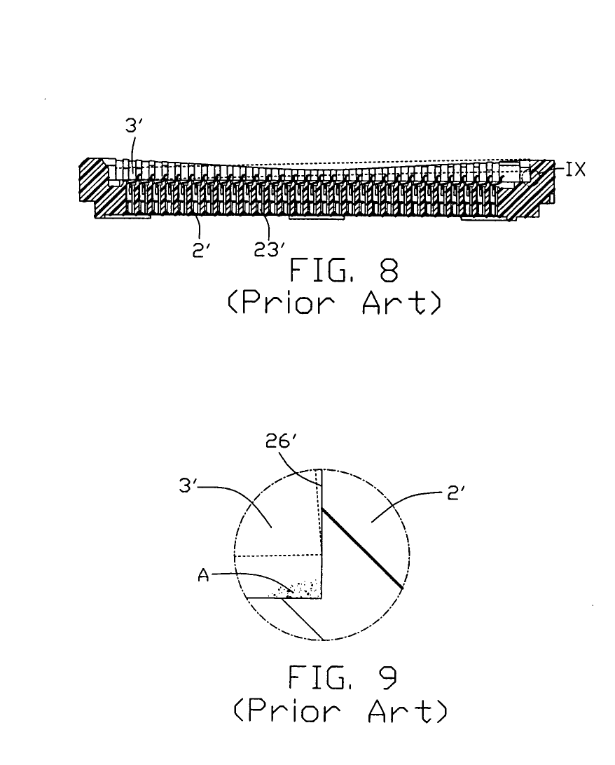

In insertion, once the CPU chip3 is positioned on the housing 2, the lever 6 is rotated down from a vertical position to a horizontal position. The cam portion 64 of the lever 6 urges the engaging portion 500 of the load plate 5. Then the load plate 5 presses onto the CPU chip 3. And the pressing portions 54 of the load plate 5 push the CPU chip 3 downwardly. Thereby the CPU chip 3 is pressed slowly down into the housing 2. When the CPU chip 3 is slant positioned in the housing 2 (as refers to FIG. 5 or FIG. 6), or warp of the CPU chip 3 occur because the load plate 5 firstly presses the side of the CPU chip 3 near the pressing portion 504. The block member 269 can protect inner surface of the sidewalls 24,26 of the housing 2 against the CPU chip 3 from scraping damage caused by the slant and the warp of the CPU chip 3. As a result, reliable electrical connection between the CPU chip 3 and contacts 23 of the housing 2 is secured.

While the present invention has been described with reference to a preferred embodiment, the description is illustrative and is not to be construed as limiting the invention. Therefore, various equivalent modifications and changes known to persons skilled in the art according to the spirit of the present invention are considered within the scope of the present invention as defined in the appended claims.

1. An electrical connector for connecting an electronic package comprising:
an insulative housing having a floor and sidewalls extending upwardly from the floor, the floor and the sidewalls cooperatively defining a space for receiving the package therein, the floor defining a plurality of passageways therethrough;
a plurality of contacts received in the passageways of the housing, respectively; and
at least one block member disposed on the sidewalls of the housing, said block member partly protruding into the space, for protecting sidewalls of the housing from being scraped during inserting the package into the housing and during extracting the package therefrom.

2. The electrical connector as claimed in claim 1, wherein a recess is defined at joint of two adjacent sidewalls, the block member being disposed into the recess.

3. The electrical connector as claimed in claim 2, wherein the sidewalls of the housing comprise two opposite first sidewalls and two opposite second sidewalls interconnecting with the first sidewalls.

4. The electrical connector as claimed in claim 3, wherein the recess is defined at a joint between one of the second sidewalls and an adjacent first sidewall, and the block member is interference inserted into the recess.

5. The electrical connector as claimed in claim 3, wherein the recess is defined at joint of one of the second sidewalls and an adjacent first sidewall, and the block member is insert molded into the recess.

6. The electrical connector as claimed in claim 2, wherein the recess is substantially L-shaped, and it comprises a first and second surfaces, a first and second mating faces substantially perpendicular to the first and second surfaces respectively, and an inward stopping wall substantially perpendicular to and connecting with the second surface and the second mating face.

7. The electrical connector as claimed in claim 6, wherein the first and second surfaces are perpendicular to and connect with each other.

8. The electrical connector as claimed in claim 1, wherein the block member has a substantially L-shaped configuration.

9. The electrical connector as claimed in claim 8, wherein the block member comprises a first and second top surfaces, a first and second auxiliary surfaces connecting with the first and second top surfaces respectively, a first and second arcuate inner surfaces connecting with the first and second auxiliary surfaces respectively, and a first and second side faces perpendicular to and connecting with the first and second inner surfaces.

10. The electrical connector as claimed in claim 9, wherein the first and second auxiliary surfaces of the block slant downwardly.

11. The electrical connector as claimed in claim 10, wherein the first and second top surfaces of the block connect with the first and second mating faces of the recess respectively, the first and second outer surfaces engage with the first and second surfaces respectively and the second side face abuts against the inward stopping wall of the recess.

12. The electrical connector as claimed in claim 11, wherein oblique guiding faces are formed on the second sidewalls and the end of the first sidewalls of the housing, the auxiliary surfaces of the block aligning with the guiding faces.

13. An electrical connector for connecting an electronic package comprising:
an insulative housing having a floor and sidewalls extending upwardly from the floor, the floor and the sidewalls cooperatively defining a space for receiving the package therein, the floor defining a plurality of passageways therethrough;
a plurality of contacts received in the passageways of the housing, respectively; and
at least one block member having reinforced strength and disposed on at least one of the sidewalls of the housing, said block member having a portion protruding inwardly beyond the corresponding side wall, for protecting sidewalls of the housing from being scraped during inserting the package into the housing and during extracting the package therefrom.

14. The electrical connector as claimed in claim 13, wherein said block member is received in a recess formed in the corresponding side wall.

15. The electrical connector as claimed in claim 13, wherein said block member is located at a corner of two adjacent side walls.

16. A method of assembling an electronic package into a socket, comprising steps of:
providing a socket with a circumferential wall assembly;
forming a recess in one position of said circumferential wall assembly;
disposing a reinforced block member into the recess compliantly wherein said block defines a portion extending inwardly and laterally beyond the circumferential wall assembly; and
inserting an electronic package into the socket under a condition that a side edge of the electronic package hits said block member rather than the circumferential wall assembly if said electronic package is tilted.
